(19) United States
(12) Patent Application Publication
(10) Pub. No.: US 2012/0192788 A1
(43) Pub. Date: Aug. 2, 2012

(54) GRANULATION-COATING MACHINE FOR GLASS FIBER GRANULES

(75) Inventors: Bernadette F. Taquet, Soumagne (BE); Christophe G. Leruth, Mortier (BE); Pierre A. Pertoldi, Vivegnis (BE)

(73) Assignee: OCV INTELLECTUAL CAPITAL, LLC, Toledo, OH (US)

(21) Appl. No.: 13/227,932

(22) Filed: Sep. 8, 2011

Related U.S. Application Data
(63) Continuation of application No. 11/319,889, filed on Dec. 28, 2005, now abandoned.

(51) Int. Cl. B05C 3/08

(52) U.S. Cl. 118/418

(57) ABSTRACT

An apparatus and method for producing glass fiber granules includes an applicator for applying a binder composition to the chopped strand segments; and a granulating assembly for imparting a cascading pseudo-helical action to the chopped strand segments. The granulating assembly includes a plurality of scoops positioned in a pattern within a rotating drum.

### TECHNICAL FIELD AND INDUSTRIAL APPLICABILITY OF THE INVENTION

The present invention relates to the manufacture of glass fiber granules. An apparatus and process for making polymer coated glass fiber granules combines multiple segments of a chopped multi-fiber glass strand into granules and coating the granules with a polymeric material. Such granules provide a convenient'form for the storage and handling of chopped glass fibers used as reinforcing materials in composite structures.

### BACKGROUND OF THE INVENTION

Chopped glass fibers are commonly used as reinforcement materials in thermoplastic articles. Typically, such fibers are formed by drawing molten glass into filaments through a bushing or orifice plate, applying a sizing composition containing lubricants, coupling agents and binder composition resins to the filaments, gathering the filaments into strands, chopping the fiber strands into segments of the desired length, and drying the sizing composition. These chopped strand segments are thereafter mixed with a polymeric resin, and the mixture supplied to a compression- or injection-molding machine to be formed into glass fiber reinforced plastic articles. In particular, the chopped strands are mixed with granules of a thermoplastic polymer, and the mixture supplied to an extruder wherein the resin is melted, the integrity of the glass fiber strands is destroyed, and the fibers are dispersed throughout the molten resin. The resulting fiber/resin dispersion is then formed into granules. These granules are then fed to the compression- or injection-molding machine and formed into molded articles. It is desired that the molded articles have a substantially homogeneous dispersion of the glass fibers throughout the article.

The granules made using such granulation processes often have irregular shapes and sizes as well as an inconsistent binder distribution throughout each granule. Consequently, such granules may experience an undesirable degradation during processing, storage and handling prior to compounding. Such degradation may result in granules breaking open prematurely, resulting in the release of filaments or fuzz that can accumulate and block or impede the flow of granules through conveyors or processing equipment. Moreover, such degradation may result in actual breakage of fibers thereby causing a reduction in the average length of the fibers in the composite article, and a consequent reduction in the physical properties of the composite article.

Accordingly, a need remains for a means of imparting, in a large range of fabrication capacity, greater impact resistance and toughness to the granules to reduce the degradation such granules experience during storage and handling prior to compounding and molding. Such a need is fulfilled by the invention described in detail below.

### SUMMARY OF THE INVENTION

An apparatus for producing glass fiber granules substantially coats chopped strand segments with a binder composition from chopped segments of multi-filament glass strand. The granulating-coating apparatus includes an applicator for applying a binder composition to chopped glass segments and a granulating assembly for imparting a cascading pseudo-helical movement to the chopped strand segments to cause their coalescence into regular cylindrical granules.

The granulating assembly includes a drum rotationally mounted for receiving the chopped glass segments, with a plurality of internal scoops positioned in a pseudo-helical pattern within the drum for cascading the chopped glass segments.

A method for granulating chopped glass segments includes introducing chopped glass segments into a drum having a plurality of scoops positioned on the interior side wall. The drum is rotated about its longitudinal axis such that a supply of the chopped glass segments are raised by the scoops and then allowed to cascade from the scoop during the drum's rotation. At each of these numerous cascading cycles the granules capture on their surface droplets of the atomized binder composition. The chopped strand segments are agglomerated into a granule. The granule grows according to an “onion layer” building process. The cascading, tumbling and rolling action imparted to the young granules causes the agglomerated strand segments to align and to compact themselves into a desired granule configuration.

The granule forming process and apparatus are efficient and controllably yield substantially uniform granules over a large range of capacity.

The granules have a shape, a size and a density that provide good flowability and handability. The granules do not substantially experience degradation during processing, storage and handling prior to compounding. Also, the granules do not substantially break open prematurely, release filaments or generate fuzz that can accumulate and block or impede the flow of granules through conveyors or processing equipment.

The granules are useful in the manufacture of a glass fiber reinforced product without an appreciable loss in strength characteristics in comparison to comparable products made with non-granulated chopped strands.

### BRIEF DESCRIPTION OF THE DRAWINGS

FIG. 1 is a schematic illustration of a granule forming system.

FIG. 2 is a schematic perspective illustration, partially in phantom, of a granulating assembly.

FIG. 3A is a schematic perspective illustration of a scoop.

FIG. 3B is a schematic perspective illustration of two scoops on a drum wall.

FIGS. 4A and 4B are schematic illustrations of one embodiment of a pattern scoops within a granulating assembly.

### DETAILED DESCRIPTION OF THE INVENTION

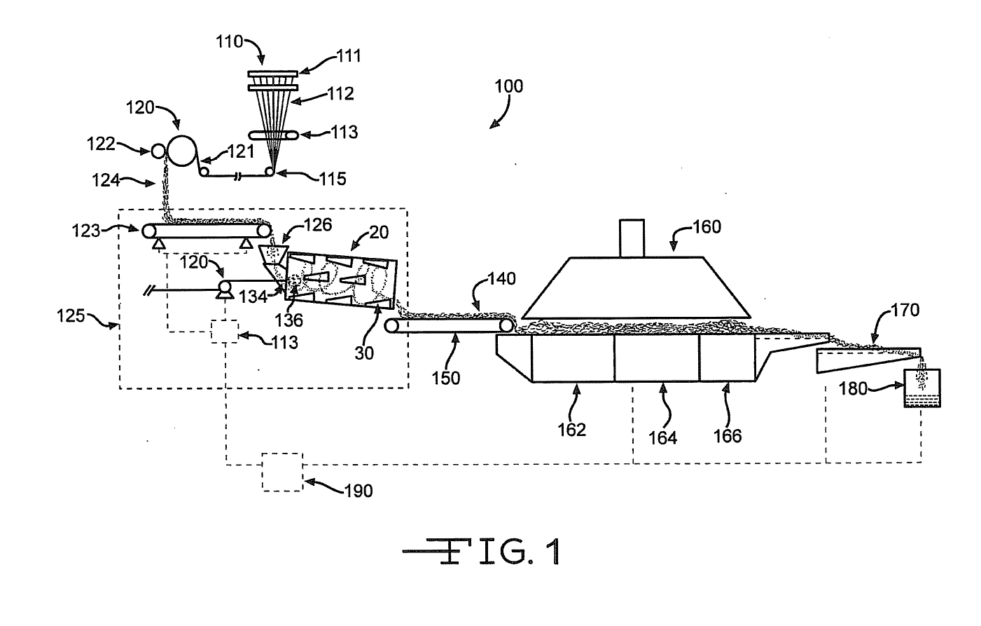

A granule forming system apparatus 100 is schematically illustrated in FIG. 1. In one embodiment, a fiber-forming apparatus 110 includes a glass fiber-forming furnace (not shown) having fiber-forming bushings 111 from which a multiplicity of filaments 112 are drawn or attenuated. Applied to the filaments 112 is an aqueous sizing composition by any suitable sizing applicator, such as rolls 113. In one embodiment, the sizing composition includes water, one or more coupling agents, and optionally, one or more film forming binding resins, lubricants and pH adjusters.

Groups of filaments 112 are collected into independent strands 115. The strands 115 and are introduced into a chopper or cutting device 120 and are cut at a point of contact between a feed roller 121 and a cutter roller 122 into segments, i.e., chopped strand segments 124 of a desired length.

The chopped strand segments 124 are conveyed by a conveyor 123 to a hopper 126 and then dispersed into a granulating assembly 125 where the chopped strand segments 124 are coated with a binder composition 136 and are densified into granules 140. In certain embodiments, the granules are coated with a thermoplastic or a thermosetting polymeric binder composition. In the latter case, the binder composition upon setting, hardening or curing (hereinafter referred to collectively as “curing”), imparts increased structural integrity and toughness to the resulting granules. The substantial coating of the granules with the binder composition improves the ability of the granules to be stored and transported with reduced granule degradation.

The resulting granules 140 are transported by conveyor 150 to an oven 160. In the oven, the granules 140 are passed through suitable drying 162, curing 164 and/or cooling 166 zones in the oven 160. The granules 140 pass through a screen assembly 170 to separate any oversized granules. The desired sized granules are delivered to a packaging station 180. In certain embodiments, the system 100 includes an apparatus 190 for monitoring and/or adjusting various parameters, which may be automatically controlled. Also, in certain embodiments, the various components of the granulating assembly 125 that come into contact with the chopped strand segments and granules are coated with suitable anti-adherent composition that is also substantially resistant to abrasion. Such coating both facilitates cleaning of the drum walls while also suitably durable to resist abrasion from the chopped strand segments and the cascading actions of such granules.

It is to be understood that in the process of the invention a strand of substantially continuous glass fibers is formed by any technique, such as drawing molten glass through a heated bushing to form a multitude of substantially continuous glass fibers and collecting the fibers into a strand. Any suitable apparatus for producing such fibers and collecting them into a strand can be used in the present invention. Suitable fibers are fibers having a diameter of from about 3 microns to about 20 microns, and suitable strands contain from about 1000 fibers to about 8000 fibers although fibers of different diameter and strands having a different number of fibers can be used. In one embodiment, the strands formed in the process of the invention contain from about 1200 fibers to about 4000 fibers, and the fibers have a diameter of from about 9 microns to about 17 microns.

The moisture content of the chopped strand segments can be adjusted to a level suitable for the formation of granules. The moisture content can be between about 8 percent to about 16 percent, and in certain embodiments, about 10 percent to about 14 percent. If the moisture content is too low, the strands tend not to combine into granules, but will remain in a strand formation. Conversely, if the moisture content is too high, the strands tend to agglomerate or clump or form overly large granules and/or granules having an irregular, non-cylindrical shape.

The granulating apparatus 125 cascades the chopped strand segments 124 so that: (1) the strands become substantially uniformly coated with the binder composition, and (2) multiple chopped strand segments align into successive layers of chopped strand segments and binder, thereby coalescing into granules having a desired size and shape. The granulating apparatus 125 provides an average residence time of the granules in the drum which is sufficient to insure that the chopped strand segments become substantially coated with the binder composition and form granules, but an insufficient time for the granules to be damaged or degraded through abrasion by rubbing against one another. In certain embodiments, the residence time in the granulating apparatus is between about 1 minute to about 5 minutes. In certain other embodiments, the residence time in the granulating apparatus is between about 1 minute to about 3 minutes.

The amount of binder composition 136 applied onto the chopped strand segments 124 is proportional the flowrate of the chopped strand segments 124 passing through the granulating assembly 125. The amount of binder composition and the flowrate of the chopped strand segments 124 are controlled to ensure a desired granule solid content output.

The granulating apparatus 125 includes a rotating drum assembly 20 and a metering device 113 for supplying a desired quantity of binder composition into the drum assembly 20. Depending on the particular embodiment, the binder composition can be either applied at ambient temperature or be preheated (for example, up to about 80° C.) before application on the chopped glass segments 124.

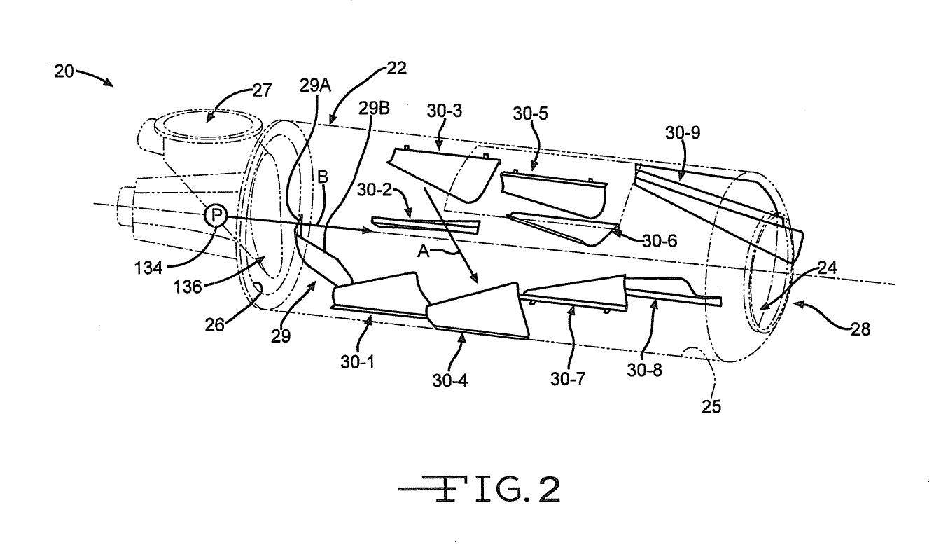

Referring now to FIG. 2, one or more nozzles 134 are operatively connected to the drum assembly 20 for delivering a quantity of binder composition 136 into the drum assembly 20. In certain embodiments, the nozzle 134 substantially atomizes the binder composition as the atomized binder composition 136 is being dispensed into in the drum assembly 20. In certain embodiments, the binder composition 136 and a supply of air are combined into one fluid stream before being dispensed into the drum assembly 20 through the nozzle 134.

In certain other embodiments, the binder composition and air are delivered through separate nozzle orifices such that the air and binder composition are combined into one atomized stream in the drum assembly 20. In certain embodiments, the nozzle 134 generates a conical spray which is oriented into the drum assembly 20 in such a way to maximize the contact between the chopped strand segments 124 and the binder composition droplets mist propelled on the strand segments.

In one embodiment, a stream of cleaning air surrounding the spray device is blown through the drum assembly 20 to push back any flying fuzz from the nozzle environment, to prevent the spray clogging and to keep the environment clean. This airflow can either be at ambient temperature or preheated in a range of 25 to 40° C. to pre-dry the granules 140 exiting the granulating assembly 125.

The chopped stand segments 124 contact the binder composition droplets. The chopped strand segments 124 are coated with the binder composition droplets and adhere to adjacent chopped strand segments. The certain of the chopped strand segments tend to align with one other chopped strand segments and coalesce into a generally cylindrically shaped granule. In certain embodiments, the resulting granule 140 has a diameter that is between about 12% to about 50% of its length.

Fines or single fibers (which were created during the chopping operation) are recombined with, and incorporated into, the forming granules which greatly reduces or eliminates individual fine fibers or fuzz.

The size of the granules is affected by the moisture content of the strands segments entering the drum assembly 20 and the quantity of water introduced into the granulating assembly 125. The more water is added, the bigger the granule size and vice versa. The quantity of binder composition relative to the amount of chopped strand segments introduced into the drum assembly also affects the granule size. The more binder composition that is added, the bigger the granule size and vice versa. The size of the granules is also affected by the drum throughput. If the drum throughput is high, the chopped strand segments have a shorter residence time in the drum. The shorter residence time tends to result in the formation of smaller granules. Granules that are in the drum for a shorter period of time tend to undergo less compaction. The residence time in the drum can also be controlled by adjusting the slope of the drum inclination from about 0 to about 10°. The higher is the slope, the shorter is the residence time and, consequently, the granule size.

In certain embodiments, useful binder compositions may include polyvinyl alcohol, polyvinyl acetates, polyvinyl pyrollidone, tetrafluoroethylene fluorocarbon polymers (e.g., Teflon), acrylics, acrylates, vinyl esters, epoxies, starches, waxes, cellulosic polymers, polyesters, polyurethanes, silicone polymers, polyether urethanes, polyanhydride/polyacid polymers, polyoxazolines, polysaccharides, polyolefins, polysulfones and polyethylene glycols. Such binders are thermoplastic materials or can be cured with heat or exposure to radiation. In certain other embodiments, the preferred binder compositions provide a high strength coating and include polyurethanes, polyacids polymers, epoxies and mixes thereof.

In certain other embodiments, the binder composition can comprise as disclosed in Campbell et al. U.S. Pat. No. 6,846,855 B2; Masson et al. U.S. Pat. No. 6,365,272 B1; and in US patent applications, Piret et al. Pub. Nos. 2004/0258912 and Piret et al. 2004/0209991, assigned to the same assignee as the present invention, which applications are expressly incorporated herein by reference in their entirety.

Examples of suitable binder compositions that can be used include the following compositions (unless indicated otherwise, all percentages are by weight):

TABLE 4
From US 2004/0209991 A1 § (0042)

| Component of Binder composition | % by Weight of Active Solids |
|---|---|
| Maldene 286 (a) | 57 |
| Baybond PU-403 (b) | 29 |
| Silquest A-1100 (c) | 8 |
| Pluronic F-77 (d) | 0.7 |
| Pluronic PE-103 (e) | 2 |
| Pluronic L-101 (f) | 0.7 |
| Triton X-100 (g) | 2 |

(a): maleic acid/butadiene copolymer, partial ammonium salt (Lindau Chemicals, Inc.)
(b): polyurethane dispersion (Bayer)
(c): aminopropyltriethoxysilane (GE Silicones - OSi Specialties)
(d): oxirane (EO-PO copolymer) (BASF)
(e): oxirane (EO-PO copolymer) (BASF)
(f): oxirane (EO-PO copolymer) (BASF)
(g): octylphenoxypolyethoxyethanol

TABLE 3
From US 2004/0258912 A1 - § (0075)

| Component of Binder composition | % by Weight of Active Solids |
|---|---|
| Neoxil 962D (a) | 44.7 |
| Neoxil 8294 (b) | 44.7 |
| VP LS 2277 (c) | 10.6 |

(a): Neoxil 962D is a non-ionic aqueous emulsion of an epoxy-ester resin
(b): Neoxil 8294 is a non-ionic aqueous emulsion of a flexible epoxy resin
(c): VP LS 2277 is an aqueous polyurethane dispersion

The foregoing are examples of binder composition formulations that have been evaluated and found useful in the process of the invention. The artisan may select other suitable binder composition formulations or other components that may be used. Many aqueous sizing formulations used in glass fiber forming technology are useful as binders for spraying onto the fibers in the granulating apparatus in accordance with the process of the invention.

The granules exhibit enhanced toughness and ability to withstand handling with reduced degradation during processing, storage and handling prior to compounding into an end product. The granules resist breaking open prematurely, releasing filament or generating fuzz that can accumulate and block or impede the flow of granules through conveyors or processing equipment. Yet, the chopped glass segments within the granules disperse quickly during compounding once the granule is broken. The substantially uniform granules allow for free-flowing of the granules and for reliable consistent feeding and dosing in the compounding process.

Moreover, because the binder composition is being applied during the forming of the granules, the quantity of binder composition required to provide the desired integrity is typically lower than that which would be required if the binder composition were applied to the individual strands prior to or after granule formation. Applying the binder composition throughout the forming of the granules can reduce the overall percentage of waste of both binder composition and in any irregularly shaped (including too large) granules.

Such granules are especially useful in the manufacture of a glass fiber reinforced composite without an appreciable loss in strength characteristics in comparison to comparable products made with non-granulated chopped strands.

Referring now to FIG. 2, the drum assembly 20 includes a rotating drum 22 having a cylindrical shaped interior side wall 24. The drum wall 22 defines a chamber 25 within the drum 22.

In certain embodiments, the drum 22 is positioned in a substantially horizontal orientation. In certain other embodiments, the drum 22 is oriented at a desired angle. The slope of the drum 22 as well as the rotation speed of the drum 22 can vary, depending on the type of granule desired by the end user. Also, in certain embodiments, the drum 22 can be mounted on wheels (not shown) or the like for movement to other production lines.

The drum 22 has an inlet end 26 and an outlet end 28. The chopped strand segments 124 enter the drum 22 through an opening 27 in the inlet end 26. The chopped strand segments 124 are moved through the drum 22 from the inlet end 26 toward, and out of, the outlet end 28 by the rotation of the drum 22. The chopped strand segments 124 are under the influence of gravity as the drum 22 is rotated. A desired quantity of atomized binder composition 136 is introduced through the nozzle 134 into the drum 22.

The drum 22 includes a deviator plate 29 which extends from the inlet end 26 into the chamber 25. The deviator plate 29 includes a mounting section 29A and a deflecting section 29B. In certain embodiments, the deflecting section 29B extends at about a 60° from a plane defined by the inlet end 26.

The drum 22 also includes a plurality of scoops 30 mounted on the wall 24 of the drum 22. The scoops 30 are positioned in a desired pattern on the wall 24. In the schematic illustration in FIG. 2, the scoops 30 are labelled 30-1 through 30-9. It is to be understood that the number and the length of scoops 30 arranged in the drum 22 can depend, at least in part, on the length and/or diameter of the drum 22 and the desired residence time of the chopped glass segments within the drum 22.

The scoops 30 are arranged in a suitably spaced relation one to another so that a supply of the chopped glass segments 124 is lifted by a first scoop 30-1 as the drum 22 is rotated about its longitudinal axis. As the drum 22 rotates, the scoops are raised in an upward circumferential direction. A supply of chopped stand segments 124 within each scoop 30 is discharged in a cascading manner onto that portion of the interior wall 24 that is at a bottom of the rotation of the drum 22. The supplies of granules are then raised again by the following, empty, scoop.

In certain embodiments, the scoops 30 are aligned such that, as the chopped glass segments 124 enter the drum 22, the chopped glass segments 124 are cascaded by the deviator plate 29 before contacting the first scoop 30-1. The movement of the chopped glass segments 124 in the drum 22 and the close mixing of the chopped glass segments 124 with the binder composition leads to the formation of granules 140 by agglomeration. That is, as the chopped glass segments 124 cascade through the spray of atomized binder composition, granules 140 of the chopped glass segments 124 are formed. The movement also causes the densification of the granules 140. For ease of explanation, the chopped glass segments 124 being formed into granules 140 through their journey through the drum 22 will be generally be referred to hereinafter as granules 140. At each of these numerous cascading events, the granules 140 capture on their surfaces droplets of the binder composition. The droplet coating of binder composition causes agglomeration of additional chopped strand segments on the granule seed; in short, the granule grows according to an “onion layer” building process. The cascading, tumbling and rolling actions imparted to the young granules causes the agglomerated chopped glass segments to align and to compact themselves into a generally uniformly shaped and sized granule.

The granules fall in successive planar streams, or curtains, within the drum 22, as generally shown by the arrow A in FIG. 2.

The cascading granules fall in a generally forward direction toward the outlet end 28. During these cascading events, additional incoming chopped strand segments 124 and the forming granules 140 are coated with the binder composition, as generally shown by the arrow B in FIG. 2.

Each cascading event from one scoop 30-1 to the next scoop 30-2 moves the granules 140 along a pseudo-helical path through the drum 22. In the embodiment shown herein, the pseudo-helical path is a non-continuous helix; that is, a series of non-continuous helix paths where the granules are “stopped” or held in each scoop before continuing onto a subsequent, and short, helical path.

The scoops 30 force the wet chopped glass segments 124 to follow a pseudo-helical path in the rotating drum 22 through a series of cascading events within the drum 22. In certain embodiments, the granules 140 fall successively from each scoop 30 as a series of curtains, or planar streams, of granules 140. The scoops 30 have a configuration which allows the curtains of granules to be substantially thick and uniform, without any gaps in the curtain. The curtains of cascading granules 140 contact the droplets of binder composition and cause the binder composition to be substantially consumed, or intercepted, by the cascading granules 140.

The growing granules 140 are thereby continuously coated with the binder composition so that there is very little or no waste of the binder composition. Each resulting granule 140 thus has binder composition substantially evenly distributed throughout the granule. In certain embodiments, the binder application efficiency is between about 85% to about 95%, versus about 65-75% for conventional sizing allocation efficiency.

The scoops 30 may be made of any material that will withstand the operating conditions inside the drum and can be attached to the drum wall 24 by bolts, screws, welding or other suitable means 33. In certain embodiments, the wall 24 and the scoops 30, which inevitably come into contact with the chopped glass segments and binder, are coated with a non-adherent polymer coating to facilitate cleaning. Where fastening hardware such as bolts or screws are used, the scoop 30 has a flange 32 formed therein to facilitate attachment of the scoop 30 to the wall 24.

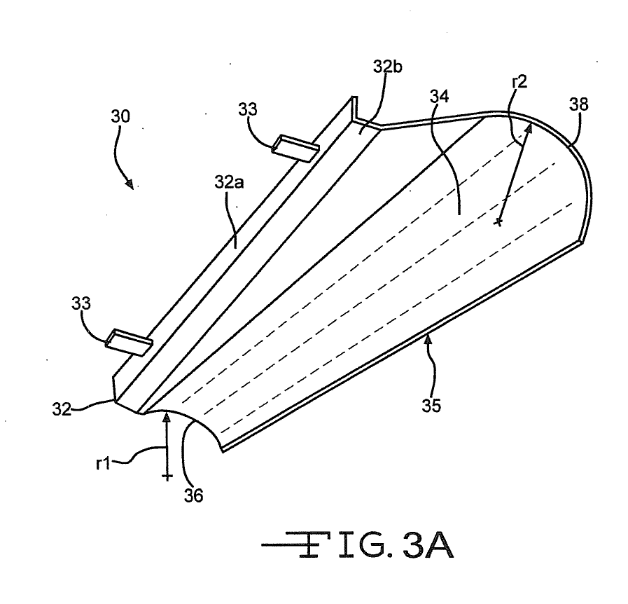

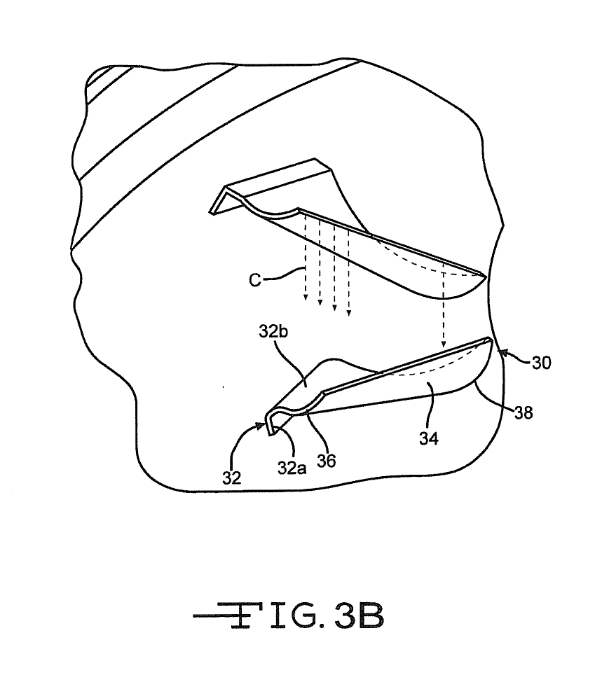

In certain embodiments, as shown in FIGS. 3A and 3B, the scoop 30 includes a flange 32 for attachment to the drum wall 24. In the embodiment shown, the flange 32 has an attachment section 32a for mounting to the interior wall 24 which is generally coterminous with the length of the scoop 30. Also, in the embodiment shown, the flange 32 includes an extending section 32b which holds a capturing member 34 at a desired distance from the interior wall 24. The capturing member 34, in turn, has a capturing edge 35. In certain embodiments, the capturing member 34 of the scoop 30 has a general shape of an open cornet defined by a first end 36 and a second end 38. The first end 36 has an internal radius, r₁, that is less than an internal radius, r₂, of the second end 38 such that the first end 36 is narrower than the second end 38. The capturing member 34 thus has a gradual expansion in width such that the capturing member 34 gradually flattens along its longitudinal length from the first end 36 to the second end 38.

Each scoop 30 is mounted on the drum wall 24 such that its narrow end 36 is closest to the inlet end 26 of the drum 22 and its wide end 38 is closest to the outlet end 28 of the drum 22. The rotation direction of the drum 22 is such that the capturing edge 35 of the scoop 30 dives into a supply of granules which lies at the bottom of the drum 22. The capturing edge 35 and the capturing member 34 ensure that the scoop 30 is filled as it raised.

When the capturing scoop 30 is rotated and reaches a certain angle of inclination, gravity causes the granules 140 to begin to cascade out of the scoop 30 at a cascading point along the capturing edge 35 (i.e., as the curtain of falling granules) onto the bottom bed of granules 140. As the capturing scoop 30 moves in the circumferential direction, the scoop 30 is gradually emptied. The shape of the capturing member 34 allows the capturing member 34 to hold a quantity of granules when the scoop is at its highest point of rotation. As the scoop 30 continues its rotation back toward its lowest point, the scoop 30 is further emptied. The scoop 30 provides a substantially continuous curtain of granules being deposited into the stream of binder composition for at least one quarter of the rotation of the drum 22.

In certain embodiments, once the capturing edge 35 is rotated about ¼ revolution, the granules start to cascade from the capturing member 34. The capturing member 34 provides a steady supply of the cascading granules as the scoop 30 rotates from about ¼ to about ½ revolution. The capturing member 34 holds a supply of the granules such that the last of the granules cascaded from the capturing member 34 at about ½ revolution.

During these cascading events, the incoming strand segments 124 and the forming granules 140 are contacted by the binder composition, as generally shown by the arrow B in FIG. 2. The capturing edge 35 is at an acute angle with respect to a plane defined by the drum wall 24 such that the cascading granules also fall at an oblique angle with respect to the interior wall 24 and are exposed to a desired quantity of binder composition droplets. The cascading granules 140 fall in a generally forward direction toward the outlet end 28.

It is to be understood that, in the embodiment shown, the drum 22 has multiple scoops 30 with the same configuration. In certain embodiments, each scoop 30 extends radially inward to the same depth, and extends longitudinally along the interior wall 24 for the same distance. In other embodiments, one or more of the scoops 30 can have different dimensions, such as differing lengths and/or depths of the capturing member 34. Also, in certain embodiments, the placement of each scoop 30 on the interior wall 24 can be varied to optimise the binder composition coating and residence time of the granules 140 within the drum 22. For example, the curtain of granules 140 (as shown by arrow C in FIG. 3B) falls from the first scoop 30-1 during the drum's rotation, and the curtains of granules 140 fall in a first pseudo-helical path toward the outlet end 28 of the drum 22.

The subsequent scoop, in turn, also allows the granules it has captured to fall in a second pseudo-helical path within the drum 22; and so on. It is to be noted that the speed of the rotation of the drum can be varied, to increase or decrease the length of time the product is cascaded in the drum 22.

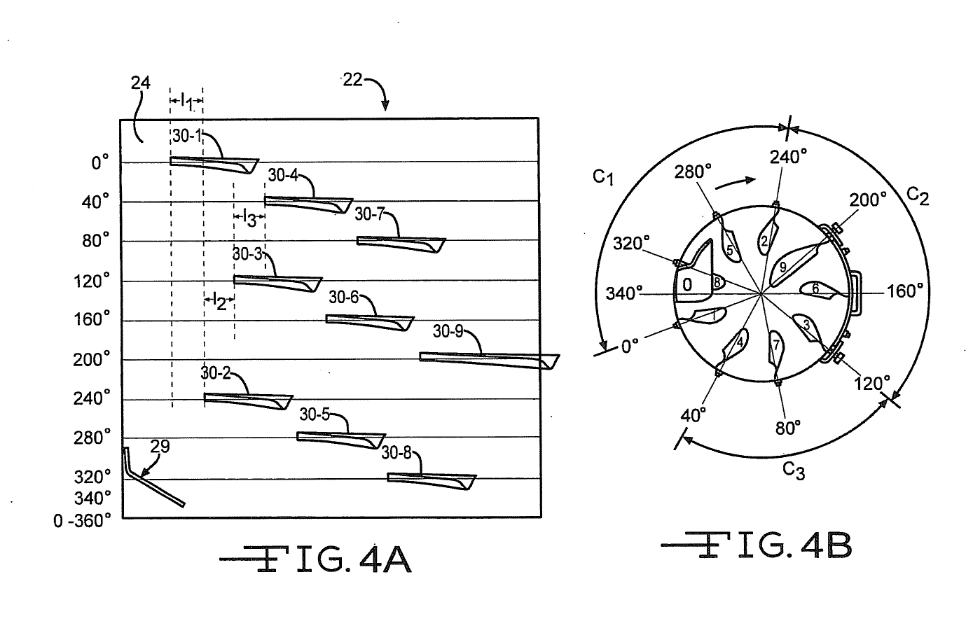

In one embodiment, as shown in FIGS. 4a and 4b, the scoops 30 are positioned in a desired pattern along the wall 24. The first scoop 30-1 is spaced at a first distance which is closest to the inlet end 26; a second scoop 30-2 is spaced at a second distance, which is farther from the inlet end 26 than the first scoop 30-1; a third scoop 30-3 is spaced at a third distance, which is farther from the inlet wall 26 than the second scoop 30-2; and so on. The longitudinal, distance, l₂, from the second scoop 30-2 to the third scoop 30-3 is the same; and so on; that is, l₁=l₂=l₃, etc:

In certain embodiments, the configured pattern of scoops provides the pseudo-helical pathway and also aids in the formation of a generally uniformly cylindrical shaped and sized granule.

FIGS. 4A and 4B show one embodiment of a pattern of scoop placement within the drum 22. Each scoop is sequentially placed along the drum's interior circumference, scoop 30, as defined by the drum's 360° circumference, as follows, where the circumferential distance between:

the first scoop 30-1 and the second scoop 30-2 is about 120°;

the second scoop 30-2 and the third scoop 30-3 is about 120°;

the third scoop 30-3 and the fourth scoop 30-4 is about 80°;

the fourth scoop 30-4 and the fifth scoop 30-5 is about 120°;

the fifth scoop 30-5 and the sixth scoop 30-6 is about 120°;

the sixth scoop 30-6 and the seventh scoop 30-7 is about 80°;

the seventh scoop 30-7 and the eighth scoop 30-8 is about 120°; and,

the eighth scoop 30-8 and the ninth scoop 30-9 is about 120°.

In certain embodiments, the last scoop 30-9 in the drum 22 can have a different configuration. For example, the last scoop 30-9 can have a greater length than other scoops, to aid in the delivery of the granules out from the drum 22.

The granules are subjected to a gradual increase in compacting and densifying leading to a better flowability of the final product. Compared to other type of granulating assembly, there is less deterioration of the resulting granules 140 occurring through impact and abrasion. The lessened tendency to deterioration of the resulting granules 140 provides improved physical properties in the glass fiber reinforced molded articles manufactured from the use of such granules 140.

Compared to a zig-zag granulator, the enlargement of the length of the large diameter chamber increases the throughput capacity of the process. For example, in certain embodiments, the drum operating at about 300 pounds (1360 kilograms) per hour without any helical scoop configuration can be increased to a capacity of about 5500 pounds (2500 kilograms) per hour by adding a helical scoop configuration.

Further, the reduction in fiber degradation resulting from the inclusion of scoops imparting the cascading movement and consequent optimized binder coating (in a “onion layer” manner) provides an increase in the integrity of the granules. The granules also have a more regular and cylindrical shape. The resulting granules also have fewer long fibers and reduced fuzz.

A method for granulating chopped glass segments includes introducing chopped glass segments into a drum having a plurality of scoops positioned on an interior side wall thereof, and rotating the drum about a generally horizontal axis. In certain embodiments, the drum can be rotated at a longitudinal axis that is at a slight angle from horizontal to aid in the longitudinal movement of the granules through the drum.

The presence of the coating binder composition substantially uniformly throughout the granule also allows the granule to be formed from strands with desired binder composition loadings and corresponding desired strand integrity, which provides for quick dispersion of the fibers once the granules are used to form the end product. Coating the binder composition throughout the granule reduces the overall percentage of waste of binder, and also reduces the amount of irregularly shaped (including too large) granules, which provides obvious economic benefits.

Various advantages of this invention will become apparent to those skilled in the art from the following detailed description of the preferred embodiments, when read in light of the accompanying drawings.

While the invention has been described with reference to specific embodiments, it should be understood by those skilled in the art that various changes may be made and equivalents may be substituted for elements thereof without departing from the essential scope of the invention. In addition, many modifications may be made to adapt a particular situation or material to the teachings of the invention without departing from the essential scope thereof. Therefore, it is intended that the invention not be limited to the particular embodiments for carrying out this invention, but that the invention will include all embodiments falling within the scope of the claims.

1. An apparatus including a rotating drum having an interior side wall and a plurality of scoops mounted in a pattern within the rotating drum for producing glass fiber granules substantially coated with a binder composition from chopped strand segments comprising:
an applicator for applying a binder composition to the chopped strand segments;
wherein the pattern of the plurality of scoops mounted within the rotating drum is configured to allow the chopped strand segments to follow a pseudo-helical path in the drum; and
wherein the plurality of scoops are sequentially spaced along a circumference of the interior side wall of the rotating drum such that the circumferential differences between the sequentially placed scoops vary from within the range of from about 80 degrees to about 120 degrees.

2.-3. (canceled)

4. The apparatus of claim 1, wherein the pattern of scoops is configured to allow the granules formed from the chopped strand segments to follow a pseudo-helical path in the drum.

5.-7. (canceled)

8. The apparatus of claim 4, wherein the circumferential distances between scoops comprises:
as between a first scoop and a second scoop about 120°;
as between the second scoop and a third scoop about 120°; and,
as between the third scoop and a fourth scoop about 80°.

9. The apparatus of claim 4, wherein the pattern includes a last scoop having a longer length than other scoops in the pattern.

10.-15. (canceled)

16. The apparatus of claim 1, wherein the applicator comprises a delivery device configured to deliver the binder composition to the chopped strand segments.

17. The apparatus of claim 16, wherein the delivery device is positioned within a surrounding stream of cleaning air entering the drum along with binder composition.

18.-36. (canceled)

37. The apparatus of claim 1, wherein each of the plurality of scoops has an upstream end and the distance from the upstream end of each scoop to the upstream end of each successive scoop is the same.

38. The apparatus of claim 8, wherein the circumferential distances between scoops comprises:
as between the fourth scoop and a fifth scoop about 120°;
as between the fifth scoop and a sixth scoop about 120°; and,
as between the sixth scoop and a seventh scoop about 80°.

39. The apparatus of claim 38, wherein the circumferential distances between scoops comprises:
as between the seventh scoop and a eighth scoop about 120°; and
as between the eighth scoop and a ninth scoop about 120°.

40. The apparatus of claim 39, wherein the ninth scoop has a longer length than the other scoops in the pattern.

41. The apparatus of claim 39, wherein each of the plurality of scoops has an upstream end and the distance from the upstream end of each scoop to the upstream end of each successive scoop is the same.

42. The apparatus of claim 16, wherein the delivery devices comprises one or more nozzles positioned adjacent the drum.

43. The apparatus of claim 16, wherein the delivery device substantially atomizes the binder composition as the binder composition is being delivered to the chopped strand segments.

44. The apparatus of claim 16, wherein the delivery device combines the binder composition with a supply of air into one generally fluid stream prior to delivering the binder composition to the chopped strand segments.

45. The apparatus of claim 42, wherein each of the one or more nozzles comprise at least a first nozzle orifice and a second nozzle orifice, wherein the binder composition is delivered through one of the nozzle orifices and a supply of air is delivered through the other of the nozzle orifices, and wherein the binder composition and supply of air are combined into an atomized stream within the drum.

46. An apparatus including a rotating drum having an interior side wall and a plurality of scoops mounted in a pattern within the rotating drum for producing glass fiber granules substantially coated with a binder composition from chopped strand segments comprising:
an applicator for applying a binder composition to the chopped strand segments; and
wherein the plurality of scoops are sequentially spaced along a circumference of the interior side wall of the rotating drum such that the circumferential differences between the sequentially placed scoops vary from within the range of from about 80 degrees to about 120 degrees.

47. The apparatus of claim 46, wherein the pattern of the plurality of scoops is configured to allow the chopped strand segments to follow a pseudo-helical path in the drum.

48. An apparatus including a rotating drum having an interior side wall and a plurality of scoops mounted in a pattern within the rotating drum for producing glass fiber granules substantially coated with a binder composition from chopped strand segments comprising:
an applicator for applying a binder composition to the chopped strand segments;
wherein the plurality of scoops are sequentially spaced along a circumference of the interior side wall of the rotating drum such that the circumferential differences between the sequentially placed scoops vary from within the range of from about 80 degrees to about 120 degrees; and
wherein the circumferential distances between scoops comprises:
as between a first scoop and a second scoop about 120°;
as between the second scoop and a third scoop about 120°;
as between the third scoop and a fourth scoop about 80°;
as between the fourth scoop and a fifth scoop about 120°;
as between the fifth scoop and a sixth scoop about 120°;
as between the sixth scoop and a seventh scoop about 80°;
as between the seventh scoop and a eighth scoop about 120°; and
as between the eighth scoop and a ninth scoop about 120°.

49. The apparatus of claim 48, wherein the pattern of the plurality of scoops is configured to allow the chopped strand segments to follow a pseudo-helical path in the drum.
